(19) United States
(12) Patent Application Publication
(10) Pub. No.: US 2013/0081892 A1
(43) Pub. Date: Apr. 4, 2013

(54) HUMAN-RECHARGEABLE ELECTRIC VEHICLE

(71) Applicants: Richard Kronfeld, Minneapolis, MN (US); Lyon Smith, Winona, MN (US); Russell Bockin, Eden Prairie, MN (US); Steve Castellotti, San Francisco, CA (US)

(72) Inventors: Richard Kronfeld, Minneapolis, MN (US); Lyon Smith, Winona, MN (US); Russell Bockin, Eden Prairie, MN (US); Steve Castellotti, San Francisco, CA (US)

(21) Appl. No.: 13/633,078

(22) Filed: Oct. 1, 2012

Related U.S. Application Data
(60) Provisional application No. 61/540,633, filed on Sep. 29, 2011.

(51) Int. Cl. B60L 11/18; B62D 61/06

(52) U.S. Cl. 180/210

(57) ABSTRACT

The present disclosure is directed to an electric vehicle with human power input provided by a high output pedal-driven generator. The vehicle includes a computing device with a user interface that mimics an electric exercise bicycle, with both pre-set and custom exercise program profiles.

### CROSS-REFERENCE TO RELATED APPLICATION

This application claims the benefit of U.S. Provisional Application Ser. No. 61/540,633, titled HUMAN-RECHARGEABLE ELECTRIC VEHICLE, filed Sep. 29, 2011.

### BACKGROUND

Many workers use a bicycle as the primary means of commuting to and from work. Bike commuting is a good alternative for many urban dwellers, but still impractical for most due to factors such as weather conditions and safety. People with longer commutes may have the desire to travel by bike, but simply can't because of the time/distance each way, every day. Each U.S. rush-hour conventional auto commuter spends on average 200 hours per year driving to and from work, plus an average of 36 hours a year stuck in traffic. This results in lost productivity and wasted fuel. Further, people incur substantial expense on exercise equipment and health club memberships.

The present invention helps solve all of these problems by producing an affordable electric vehicle fused with an enclosed recumbent exercise bicycle. The experience of bike commuting, previously reserved for the most passionate sub-culture of bikers, will be opened up to the rest of the population who have a hard time riding in the rain, cold, dark, or other road conditions. The carbon fiber body provides protection from the elements while this three-wheeled vehicle travels up to highway speeds powered by an in-wheel hub motor with sufficient range to reach the office, home or other desired location. Recharge is by standard household AC current, plus contribution from the integrated exercise pedals. Finally, a mobile platform with GPS navigation links exercise profiles selected by the user to pedal resistances, simulating the hills and course of any length of road in the world, even while stuck in traffic. The present invention will allow commuters to get their exercise during time that would otherwise be spent just sitting in a car. Bicycling can reduce transportation fatalities and promote health improvement.

The primary goal of the present invention is to provide a better bike commuter vehicle—a highway speed, covered, safe, one- or two-passenger, all weather, pedal recharging electric bike. The central challenges of this project are how to build a system to vary the resistance at the pedals (like an exercise bike), send all the power that the person generates to the batteries without throwing any of it away, and generate enough power so that the rider contributes to the system as much as possible.

### SUMMARY

In general terms, the present disclosure is directed to an electric vehicle. In one possible embodiment and by non-limiting example, the electric vehicle is a, lightweight plug-in electric vehicle with human power input provided by a high output pedal-driven generator (the pedals are connected to a generator, not directly to the wheels). The electric current generated by the driver goes into the vehicle's overall system to be used for recharging the battery bank. The drive train is designed to increase and decrease pedal resistance, which translates into higher and lower levels of charging current to the battery. The entire charging system can be switched to outboard mode and thus provide on-demand portable electric power. The vehicle includes a computing device with a user interface that mimics an electric exercise bicycle, with both pre-set and custom exercise program profiles. Drive wheel(s) provide regenerative braking. A solar panel molded into the roof provides additional energy to the system. The disclosed vehicle is highway capable with a top speed of approximately 90 mph. The curb weight is approximately 600 pounds.

In one embodiment of the vehicle, the body is composed of carbon fiber. Recharge is by standard household AC current, plus contribution from the integrated exercise pedals. A tablet style mobile platform with GPS navigation links exercise profiles selected by the user or driver to pedal resistances, simulating the hills and course of any length of road in the world, even while stuck in traffic.

Reference is made throughout the present disclosure to certain aspects of one embodiment of the vehicle described herein. Such references to aspects of the presently described vehicle do not limit the scope of the claims attached hereto. Additionally, any examples set forth in this disclosure are not intended to be limiting and merely set forth some of the many possible embodiments for the appended claims. It is to be understood that the phraseology and terminology used herein are for the purpose of description and should not be regarded as limiting.

### BRIEF DESCRIPTION OF THE DRAWINGS

FIG. 1 is a side view of 1″ basic tubular aluminum frame without suspension according to one embodiment of the present invention.

FIG. 2 is a front view of 1″ basic tubular aluminum frame without suspension according to one embodiment of the present invention.

FIG. 3 is a close up view of 1″ tubular aluminum frame with battery box in place according to one embodiment of the present invention.

FIG. 4 is a close up view of 1″ basic tubular aluminum frame with battery box in place according to one embodiment of the present invention.

FIG. 5 shows seat on top of the battery box according to one embodiment of the present invention.

FIG. 6 is a close up view of the seat attached to top of the battery box, according to one embodiment of the present invention.

FIG. 7 shows front chassis detail with generator system in place according to one embodiment of the present invention.

FIG. 8 shows front chassis detail of one embodiment of the present invention from reverse angle.

FIG. 9 shows front end chassis detail according to one embodiment of the present invention.

FIG. 10 shows front end chassis detail according to one embodiment of the present invention.

FIG. 11 shows front end chassis according to one embodiment of the present invention.

FIG. 12 shows front end chassis detail according to one embodiment of the present invention.

FIG. 13 shows steering wheel and column angled down to front end according to one embodiment of the present invention.

FIG. 14 shows the steering column in top right of frame pointed downward where it is jointed before it goes into the rods attached to the wheels, according to one embodiment of the present invention.

FIG. 15 shows close up of the steering column going through middle of the frame with universal joint according to one embodiment of the present invention.

FIG. 16 shows where the steering column attaches with two hinged joints where rods attach which go out to the wheels, according to one embodiment of the present invention.

FIG. 17 shows the left side steering rod extended out through the body to the joint at the wheel for turning the wheel, according to one embodiment of the present invention.

FIG. 18 is a schematic of the front end suspension according to one embodiment of the present invention.

FIG. 19 shows a rear swing arm attached to the metal plate before shocks and springs are attached according to one embodiment of the present invention.

FIG. 20 shows a rear view of rear wheel connected to swing arm, connected to rear metal plate according to one embodiment of the present invention.

FIG. 21 shows close view of rear suspension according to one embodiment of the present invention, including wheel, swing arm and shock.

FIG. 22 shows an illustrated cutaway of the composite body according to one embodiment of the present invention.

FIG. 23 shows possible dimensions of the body from a side view, according to one embodiment of the present invention.

FIG. 24 shows possible dimensions of the body from a front view, according to one embodiment of the present invention.

FIG. 25 shows possible dimensions of the body from a top view, according to one embodiment of the present invention.

FIG. 26 is a rear right ¼ side view of the body of the vehicle according to one embodiment of the present invention.

FIG. 27 shows one embodiment of the body of the present invention just after door cut out was made.

FIG. 28 shows the interior of one embodiment of the present invention with foam reinforcements before final layer of carbon fiber and resin was laid in.

FIG. 29 shows a side view of one embodiment of the body with door and windshield cutouts.

FIG. 30 shows a rear left side view of one embodiment of the body with door installed.

FIG. 31 is a side view of one embodiment of the presently disclosed vehicle.

FIG. 32 is a top view of one embodiment of the presently disclosed vehicle.

FIG. 33 is an image of the motor design according to one embodiment of the present invention.

FIG. 34 shows the completed hub motor in the wheel according to one embodiment of the present invention.

FIG. 35 shows the motor controller in place in the vehicle according to one embodiment of the present invention.

FIG. 36 shows a schematic for how the motor controller is attached into the vehicle according to one embodiment of the present invention.

FIG. 37 shows the lithium ion battery pack installed in the vehicle battery box according to one embodiment of the present invention.

FIG. 38 shows the AC charger installed in the upper rear interior area of the vehicle according to one embodiment of the present invention.

FIG. 39 shows the energy management system installed in the vehicle according to one embodiment of the present invention.

FIG. 40 is a diagram illustrating the design and function of the electronically controlled variable resistance recharging system and human power energy generation system.

FIG. 41 shows the flywheel generator according to one embodiment of the present invention.

FIG. 42 is a schematic of one embodiment of the flywheel generator of the present invention.

FIG. 43 is a cutaway image of one embodiment of the infinitely variable in-hub bicycle transmission of the present invention.

FIG. 44 is an external view of one embodiment of the infinitely variable in-hub bicycle transmission of the present invention.

FIG. 45 shows the infinitely variable in-hub bicycle transmission connected to the generator and pedal mount according to one embodiment of the present invention.

FIG. 46 shows another view of the pedal generator with infinitely variable in-hub bicycle transmission, flywheel generator, pulley and pedal cranks, according to one embodiment of the present invention.

FIG. 47 is a top view of the infinitely variable in-hub bicycle transmission and flywheel generators in the chassis of the vehicle, according to one embodiment of the present invention.

FIG. 48 is a view of the pedal generator with infinitely variable in-hub bicycle transmission, flywheel generator, pulley and pedal cranks, according to one embodiment of the present invention.

FIG. 49 is a view of the pedal generator with the infinitely variable in-hub bicycle transmission, flywheel generator, pulley and pedal cranks according to one embodiment of the present invention.

FIG. 50 shows rider positioning within the chassis and how the generator would be pedaled according to one embodiment of the present invention.

FIG. 51 shows a top view of the pedal generator system with drive belts in place according to one embodiment of the present invention.

FIG. 52 shows a top view of the infinitely variable in-hub bicycle transmission and flywheel generators in place inside the chassis with drive belts in place, according to one embodiment of the present invention.

FIG. 53 is an example user interface according to one embodiment of the present invention.

FIG. 54 is an example user interface according to one embodiment of the present invention.

FIG. 55 shows the steering controls of the vehicle according to one embodiment of the present invention, wherein front and rear brakes are hydraulic and actuated by levers on the left and right side of the handlebars.

FIG. 56 shows a view of the steering wheel and controls according to one embodiment of the present invention.

FIG. 57 is a schematic block diagram of an example computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

### A) Frame

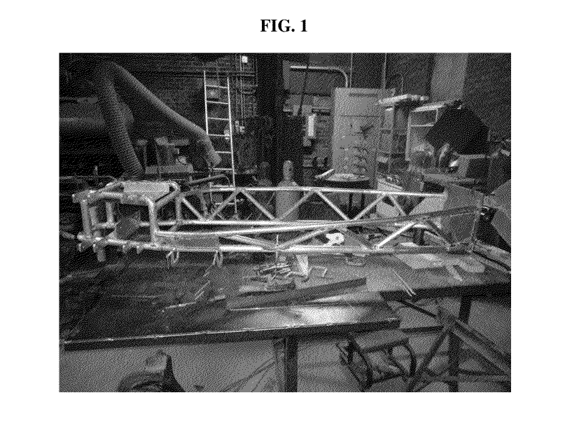

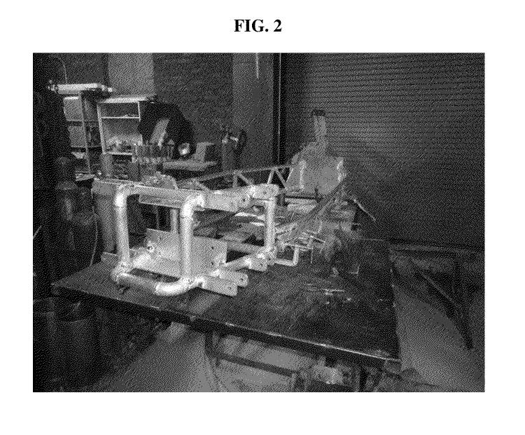

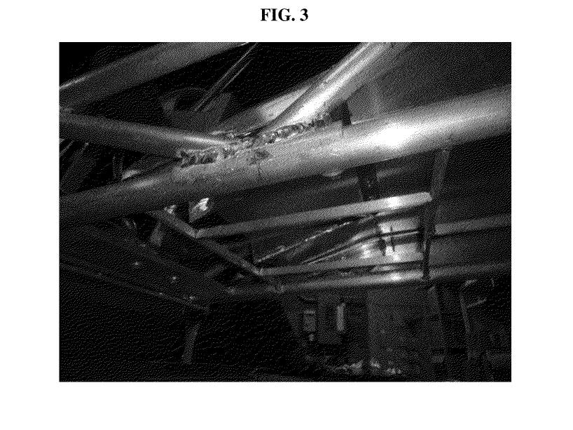

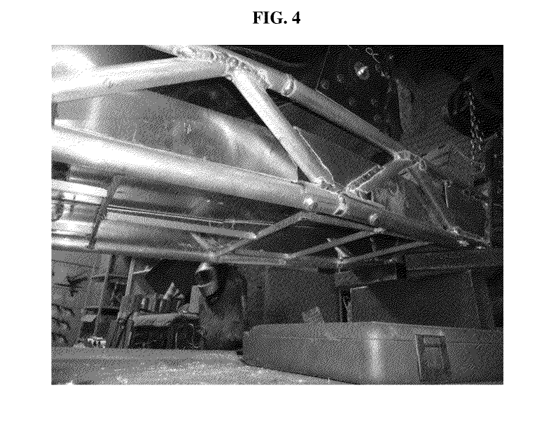

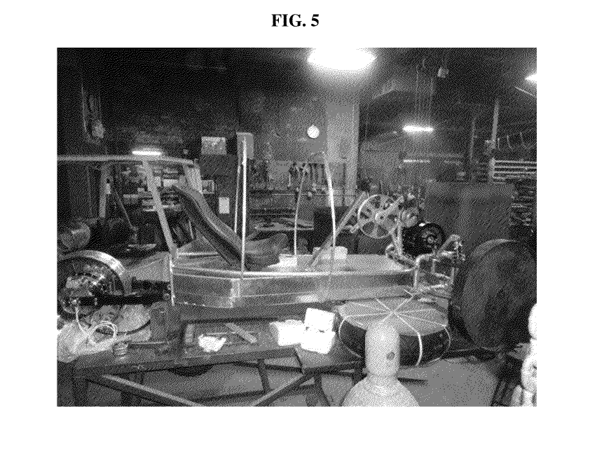

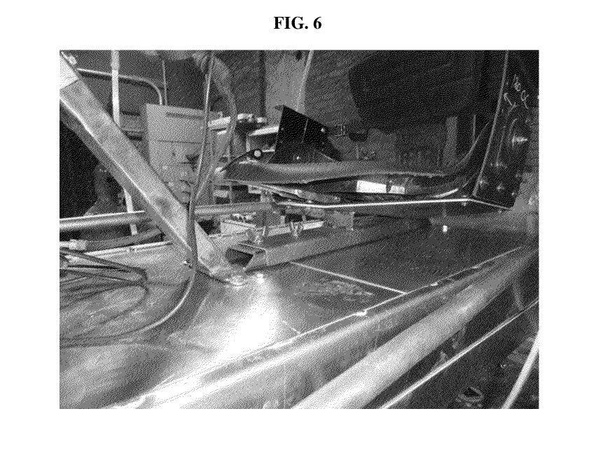

FIGS. 1 through 6 illustrate the frame of one embodiment of the vehicle in images shown from different angles. The frame is composed of 1″ diameter hollow aluminum tubing, welded together. An aluminum battery box made of ⅛″ thick aluminum sheet metal is located at the bottom of the frame in the center of the vehicle. A ¼″ thick aluminum sheet metal plate is bolted onto the frame rails on top of the battery box. The battery box is located here because it is the lowest center of gravity for the vehicle.

### B) Front End Chassis & Steering

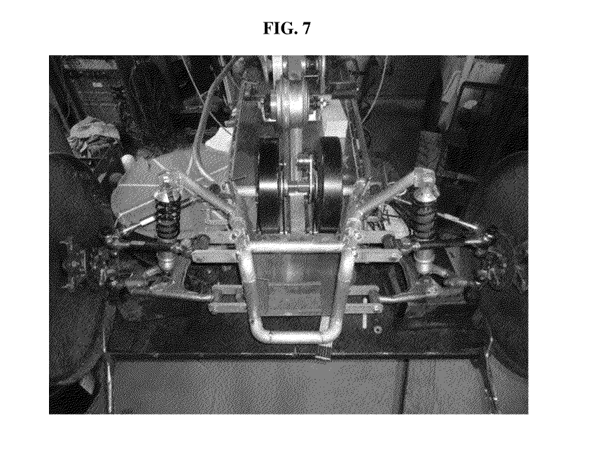

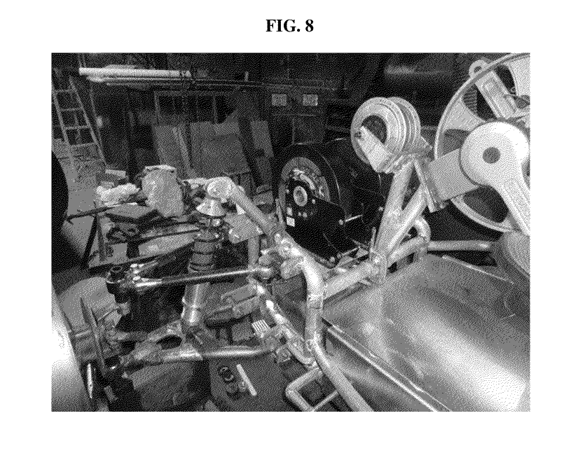

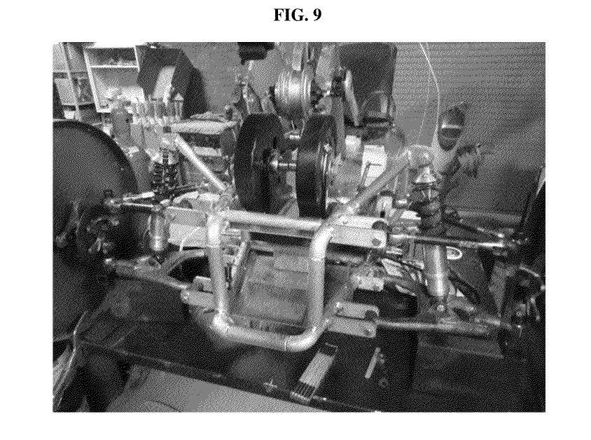

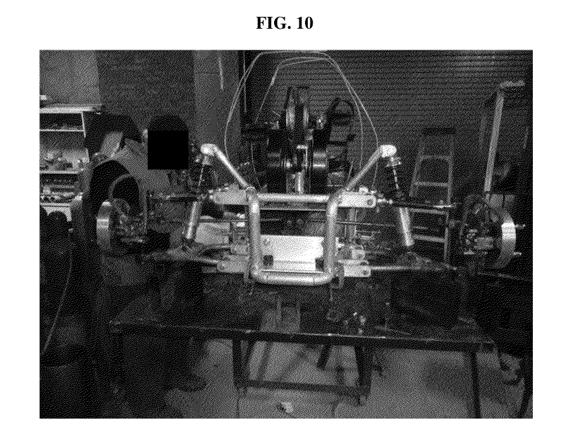

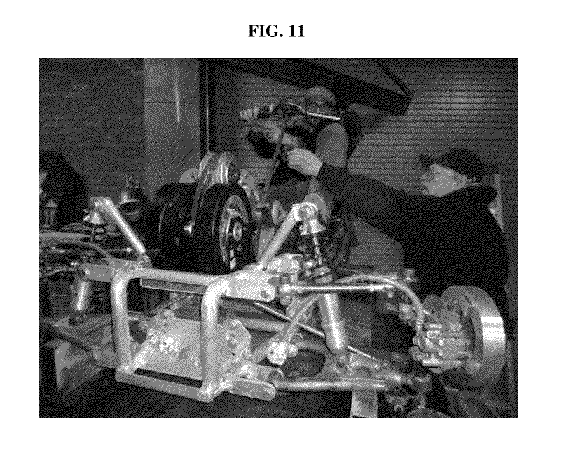

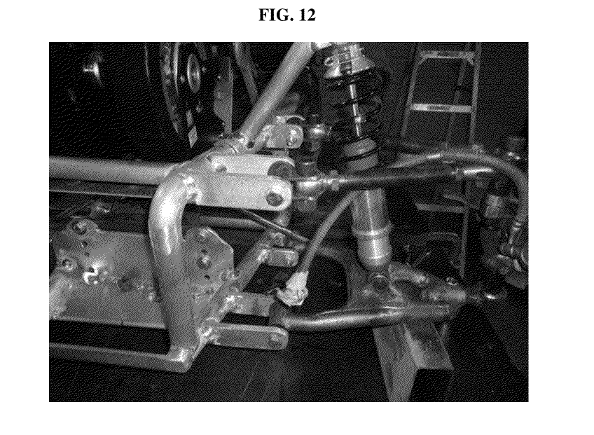

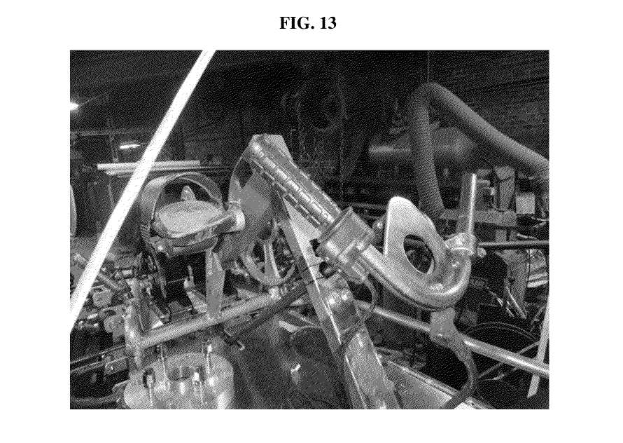

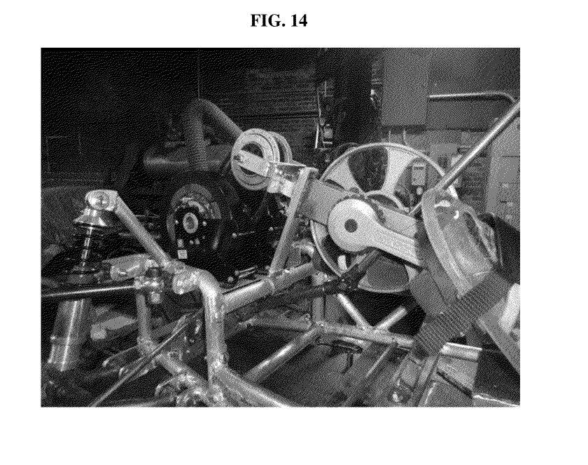

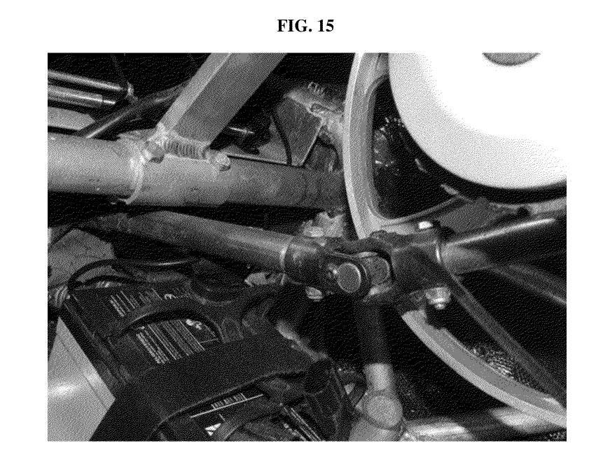

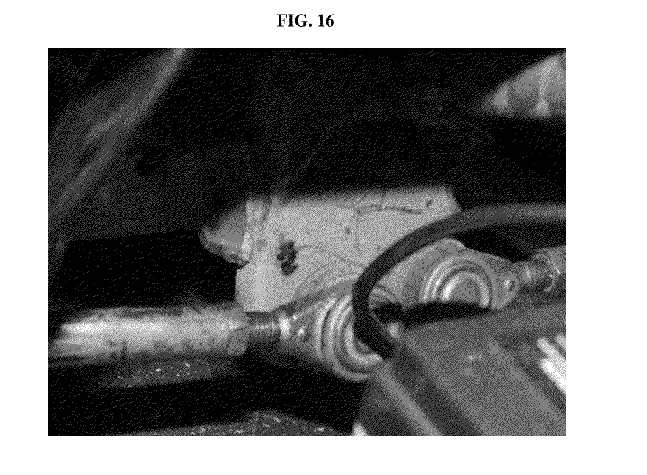

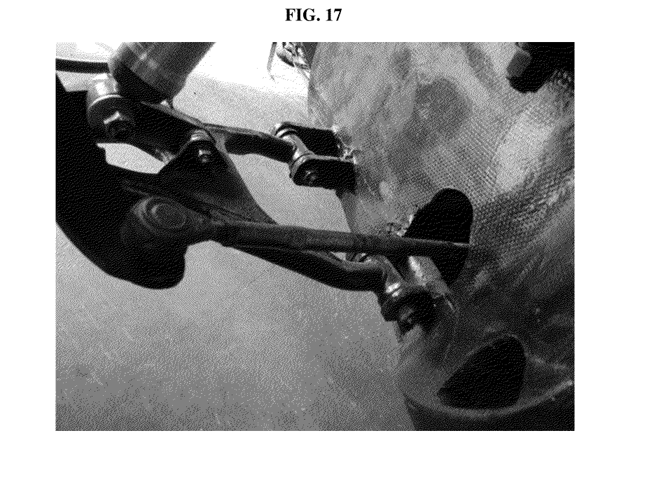

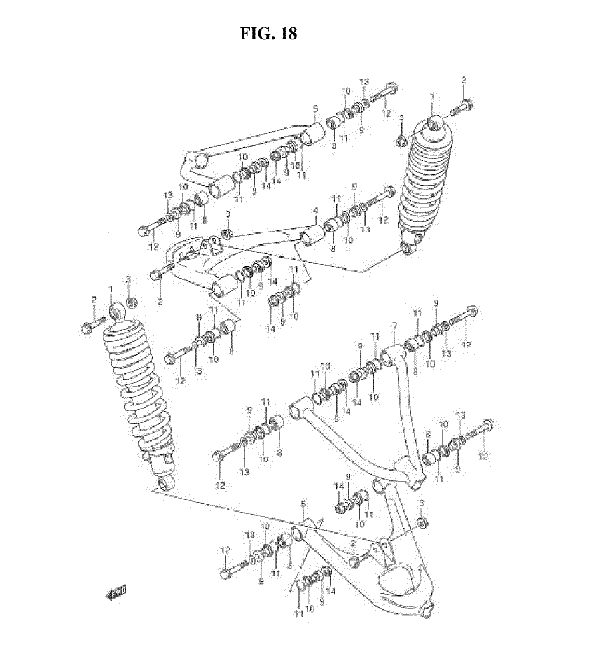

FIGS. 7 through 18 illustrate the front suspension of one embodiment of the vehicle in images shown from different angles. The front suspension is composed of an A-arm on each side, 2 tie-rods on each side, a shock absorber, a 5″ diameter hydraulic disk brake on each side, and wheel hubs on each side. A lever on the left side of the steering wheel actuates both front left and front right hydraulic disk brakes. The steering is a Mechanical Quadrant type and consists of rods attached to a central steering column on one end and attached to steel tabs connected to a bearing on either side of the front end that rotates to turn the wheel on the other end.

### C) Rear End Suspension

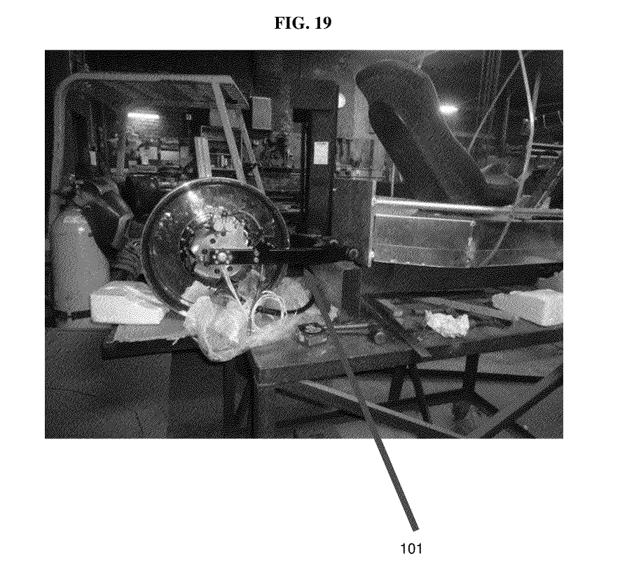

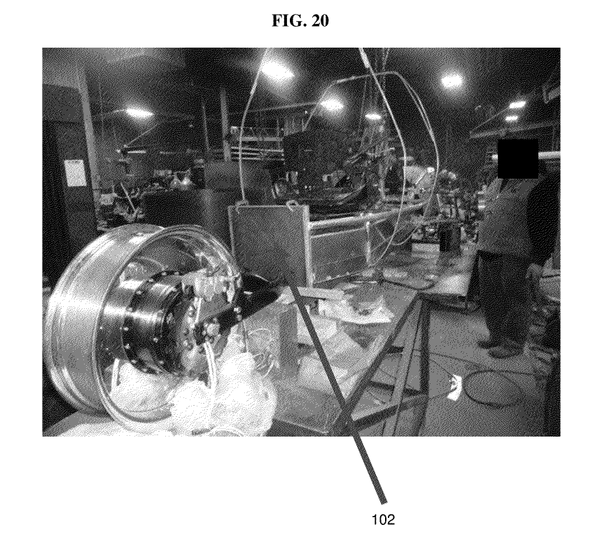

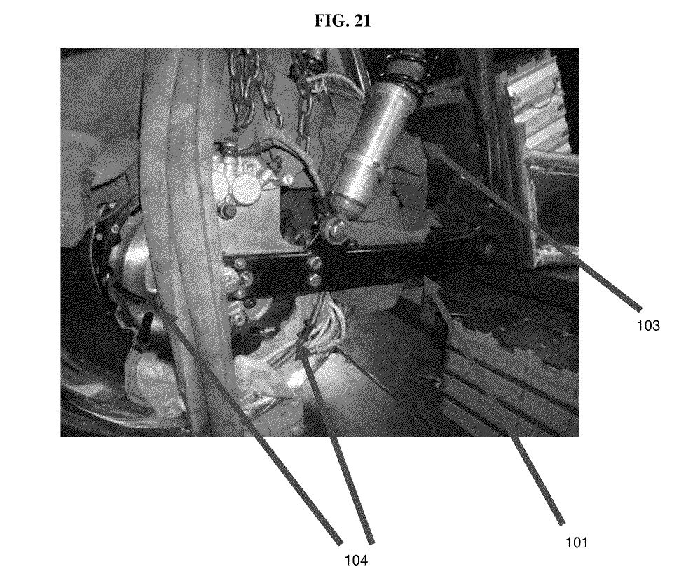

FIGS. 19 through 21 illustrate the rear suspension of one embodiment of the vehicle in images show from different angles. The rear wheel is connected to the frame via a welded steel swing arm 101 (see FIGS. 19 and 21). For strength, the swing arm is hinged to a ½″ thick aluminum plate 102 in the rear of the frame (see FIG. 20). One shock absorber 103 on each side of the swing arm is connected to the frame (see FIG. 21). An 8″ disk hydraulic brake 104 is part of the rear end suspension (see FIG. 21). A lever on the steering wheel on the right side actuates the rear brake.

### D) Body

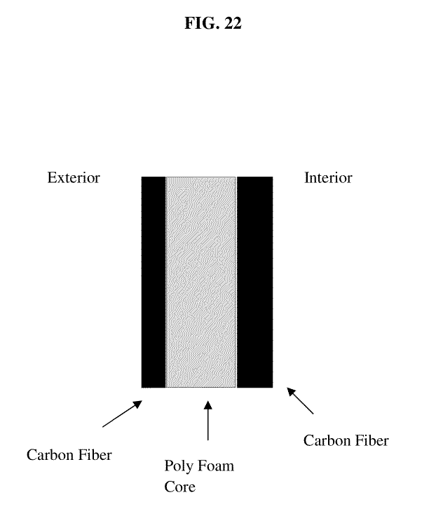

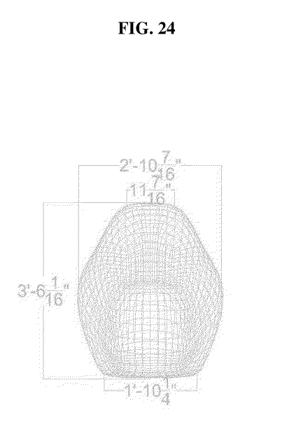

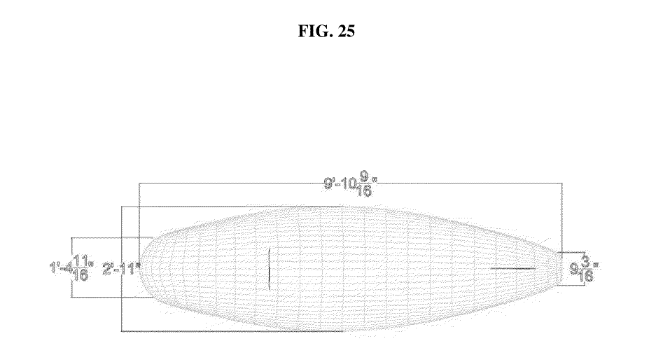

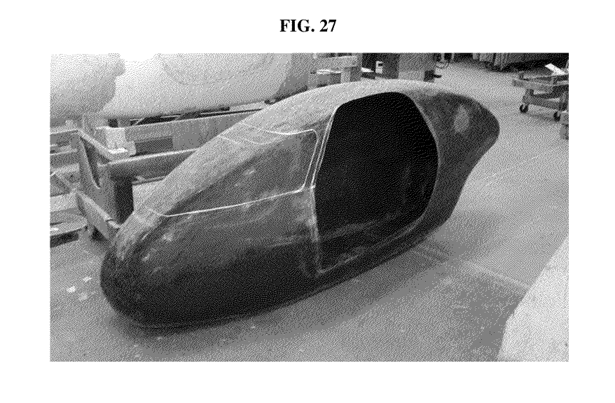

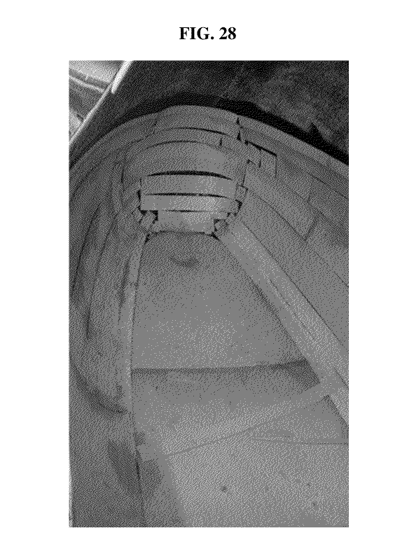

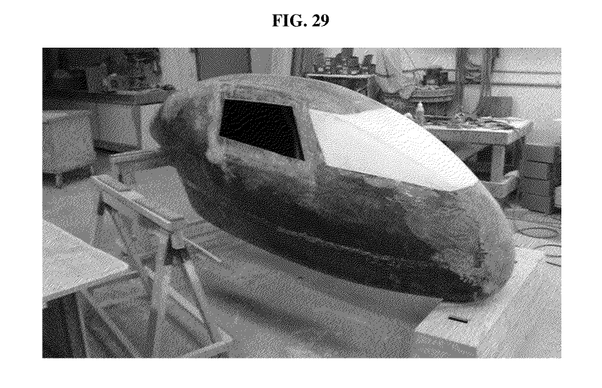

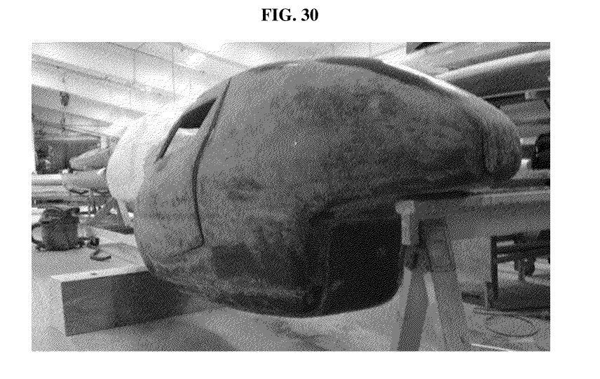

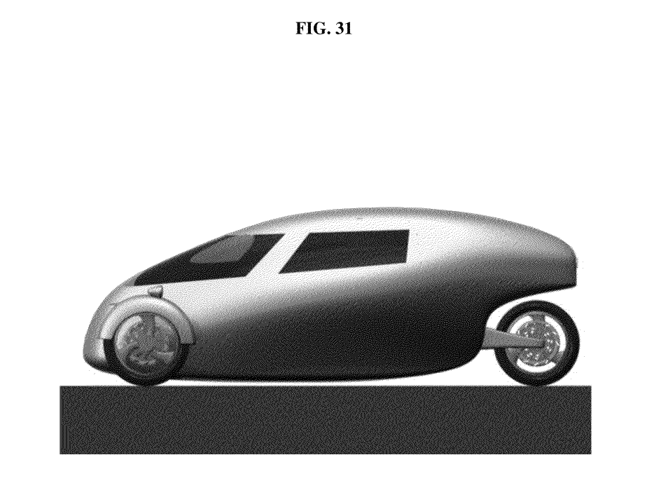

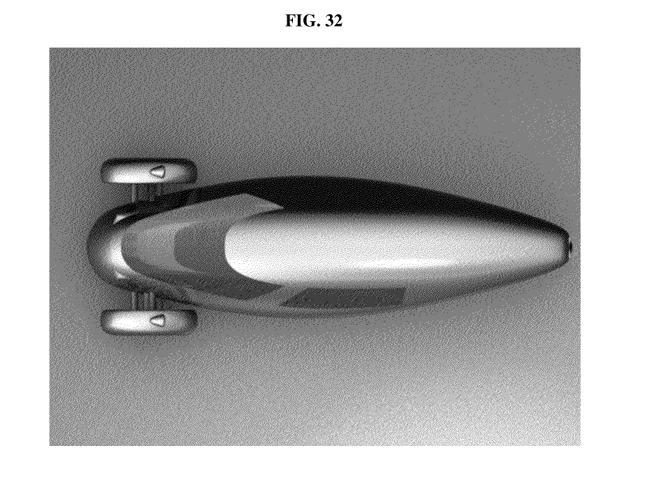

FIGS. 22 through 32 illustrate the body of the vehicle. In one embodiment, the vehicle body is made of layers of carbon fiber and flexible structural foam core (see FIGS. 22 and 28). Structural mount points and body strength will be achieved through sandwiching the foam core between layers of the carbon fiber. The thickness of the body is approximately ¼″. Alternatively, the body could be made of other lightweight metal or composite materials, such as KEVLAR, aluminum or fiberglass. The vehicle body is, in a preferred embodiment, a single piece for greatly increased strength. It is lightweight, durable and aesthetically appealing.

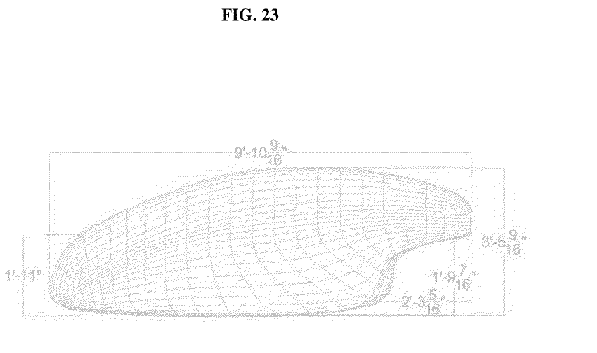

In one embodiment, the vehicle's body has external dimensions as noted in FIGS. 23 through 25. These dimensions permit a range of user or driver body dimensions to be sized for different body types, whether a child or small adult, or a larger adult.

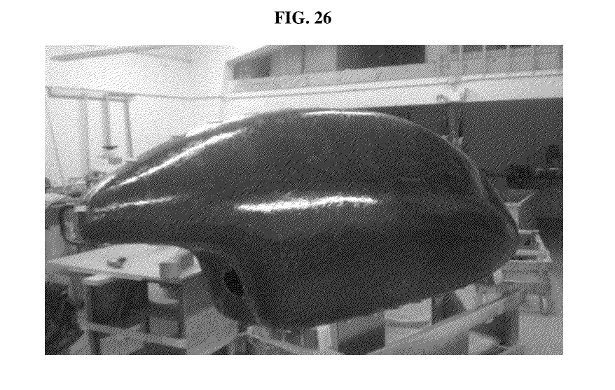

The vehicle body is designed in an elongated, semi-ovoid shape in the form depicted in FIGS. 26, 27, and 29 through 32. The shape depicted is low profile and permits low aerodynamic drag.

Further, the vehicle's exterior color could be varied to match those of user preference. Depending on the vehicle body material, the color could be integrated into the body material or applied the body exterior.

### E) Motor and Motor Controller

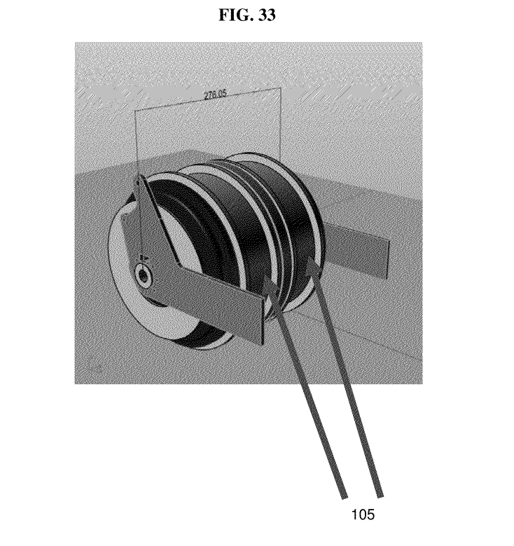

In one embodiment, the electric vehicle uses an internal hub, brushless DC motor, including two separate motor windings 105 (see FIG. 33) and housing 106 for the motor windings, with a peak power of 50 KW and constant power of 20 KW, 100 A-300 A (19-24 Hp), 10 RPM/Volt. Placing the motor in the wheel hub increases efficiency, saves space and reduces complexity by utilizing a smaller number of moving parts.

FIG. 33 shows the motor for the disclosed vehicle.

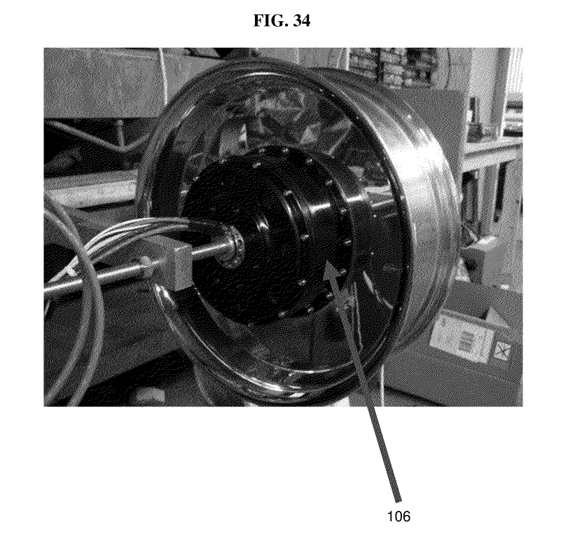

FIG. 34 shows the completed motor for the disclosed vehicle.

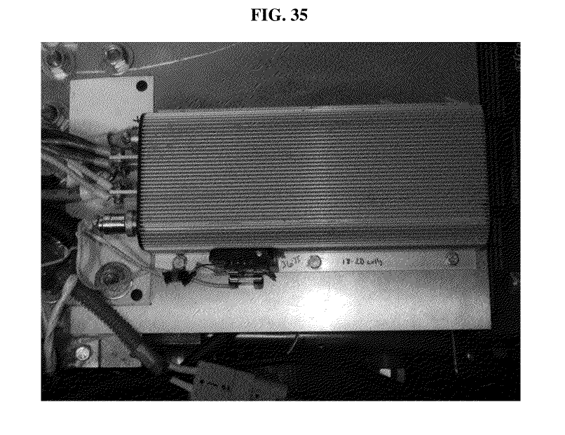

FIG. 35 shows the motor controller for the disclosed vehicle.

In one embodiment, the vehicle uses a 16.6 kHz, continuous 200 A, peak 400 A regenerative braking motor controller that manages the power flow of the battery, and motor. The motor controller monitors battery voltage. It will stop driving if battery voltage is too high. It will cut back, then stop driving if voltage is going too low. The motor controller provides regenerative braking through the motor, turning it into a generator to slow the vehicle and charge the battery. The regenerative braking feature is fully programmable and can be adjusted from little or no regenerative braking, which will allow the vehicle to coast, to maximum braking, which would slow the vehicle very quickly. The motor controller monitors motor temperature to prevent damage. The motor controller further cuts back current at low temperature and high temperature to protect battery and controller. The current will ramp down quickly if controller's temperature is higher than 90° C., and shut down at 100° C. Low temperature current ramping down usually starts at 0° C.

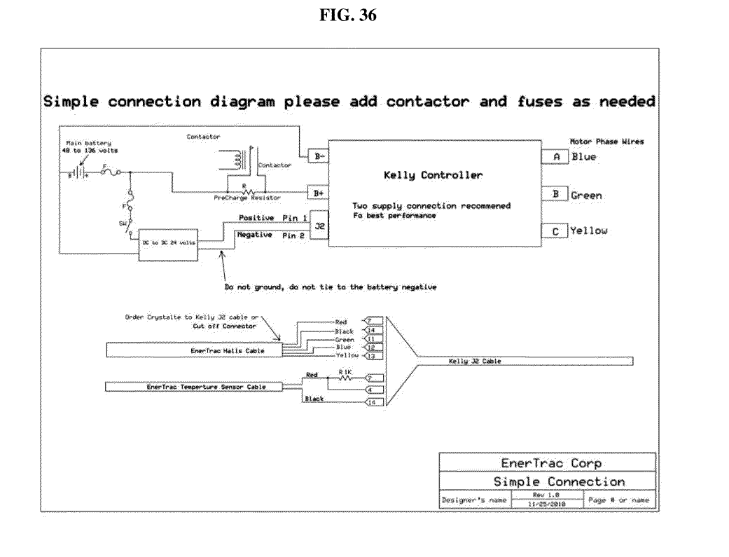

FIG. 36 shows a schematic of how the motor controller is wired into the vehicle's electrical system. Alternatively, the vehicle could use other motors or motor controllers, with varying performance capabilities.

### F) Battery and Battery Charger

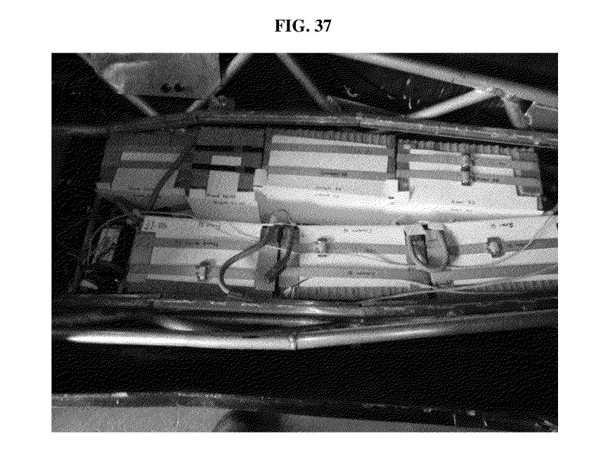

In a preferred embodiment, the vehicle uses a 4.6 kWh battery pack made up of 36, 3.2V, 40 Ah batteries in parallel, nominal voltage 120V. FIG. 37 shows the battery. The battery charge/discharge activity is handled by an energy management system (EMS) which is described in more detail below.

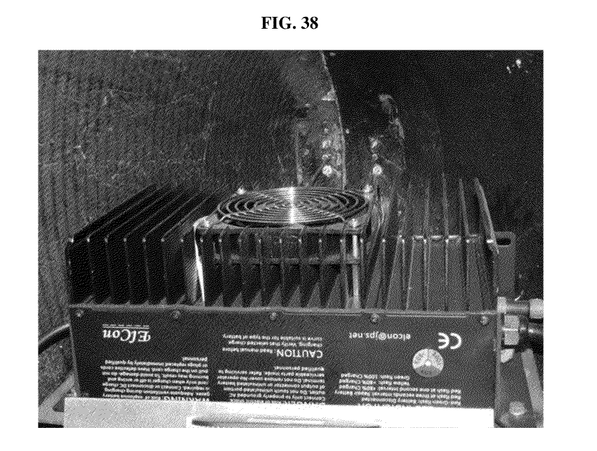

There is an 115V AC battery charger that takes in power from a standard AC wall outlet. The AC battery charger may have an input voltage range that goes beyond 115V, for example, an AC input voltage range of 85V˜265V. FIG. 38 shows the AC battery charger in place in the vehicle.

As an alternative, the vehicle could have an on-board gas or CNG (natural gas) generator to provide additional or alternative power to the drive-train.

### G) Energy Management System (EMS)

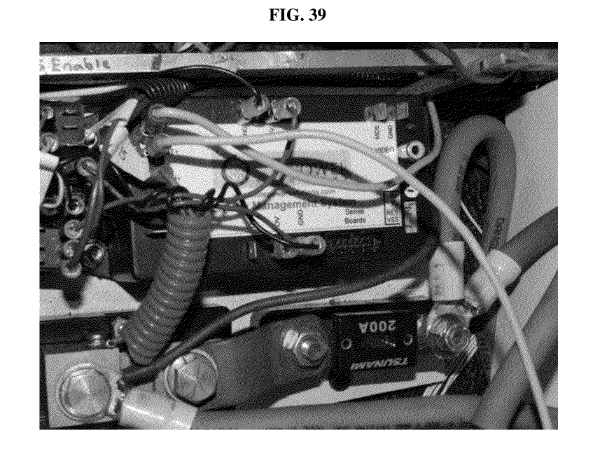

The EMS displays the condition of, and maintains the health of the batteries. It consists of two major components, the computer and the cell sense boards. The computer will tell information like the battery state-of-charge, battery current, battery voltage as well as the voltage and temperature of individual cells. FIG. 39 shows the EMS in place in the disclosed vehicle.

There are alarm outputs from the computer for cell over voltage and cell under voltage. In addition, there are warnings to let the driver know that error conditions are approaching. The EMS is designed so that the battery monitoring is completely isolated from the regular vehicle 12V system. The EMS is powered by an 8 core 32-bit microprocessor.

### H) Human Power Energy Generation System and Outboard Mode

### Human Power Energy Generation System

The vehicle as disclosed may include a pedal-driven generator system with two essential parts that make it work, as described in detail below.

Electronically Controlled Variable Resistance Recharging (ECVRR) System

The pedal function of the vehicle is intended to mimic the operation of an electronic exercise bicycle. That is, the disclosed vehicle is programmable like an exercise bicycle. The overall goal of the ECVRR component is to allow the user to dynamically adjust the “feel” of resistance at the pedals based on an arbitrary workout profile, independent of varying load on the main battery. The increased resistance felt by a user as the program varies the pedaling intensity comes from the battery pack. A dimmer switch and servomotor-controlled gear shifter are placed between the battery and the pedal generator, and are controlled by a tablet computer built into the vehicle. When the exercise program's profile calls for steep hills, the electronic dimmer switch opens up, putting a greater battery recharge load on the generators, and the servo-controlled gear shifter adjusts the gear ratio to a higher gear, making it harder to pedal. When the program calls for flat stretches, the dimmer switch closes and the servo adjusts the gear ratio to a lower gear and permits less current to go to the battery.

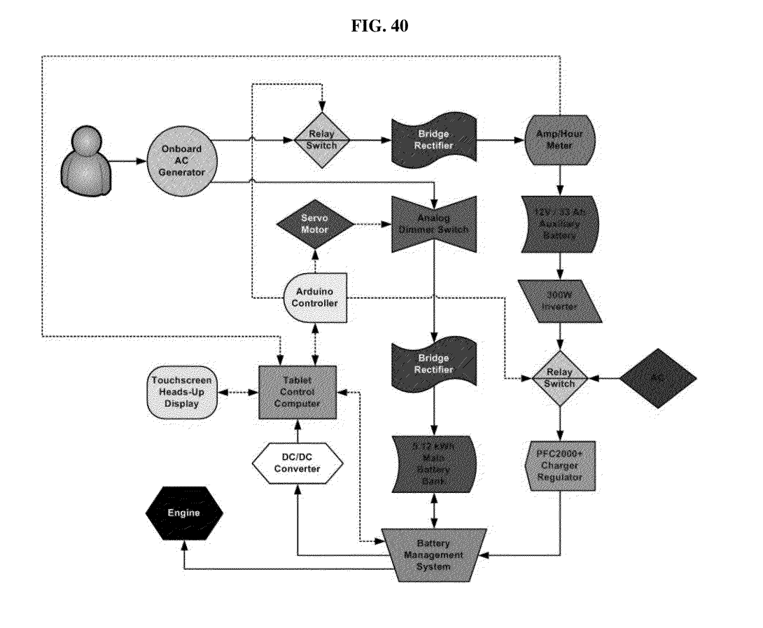

One program mode would use GPS or other location-tracking software to use terrain data as the basis for adjusting pedal resistance higher and lower. The computer, in conjunction with the generator, mimics the incline and decline of the roadway and thus produces artificial hills to provide the rider a more realistic biking experience based on actual terrain. Any energy generated recharges the vehicle's battery bank. FIG. 40 illustrates the design/function of the ECVRR. Electric exercise bicycles employ resistance systems to simulate hills and are powered by an AC outlet, or by the machines themselves with a built-in generator. Any excess power generated by the rider is thrown away. The disclosed vehicle works in a similar fashion, but power (electrical current) produced by the rider is sent to recharge the battery. In some embodiments, the pedal system of the disclosed vehicle is not tied to a generator and does not generate any power for the vehicle; the pedal system is simply used as a means of exercise or to move the vehicle while pedaling, but excess energy created by pedaling is not stored for later use.

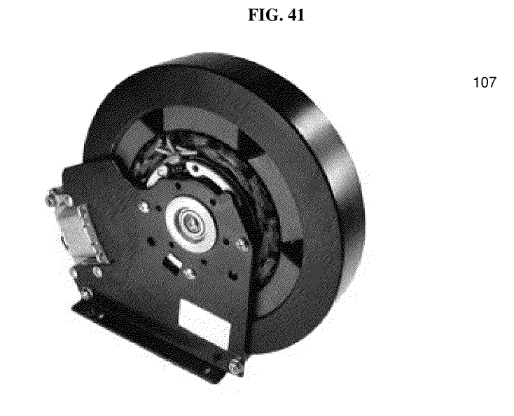

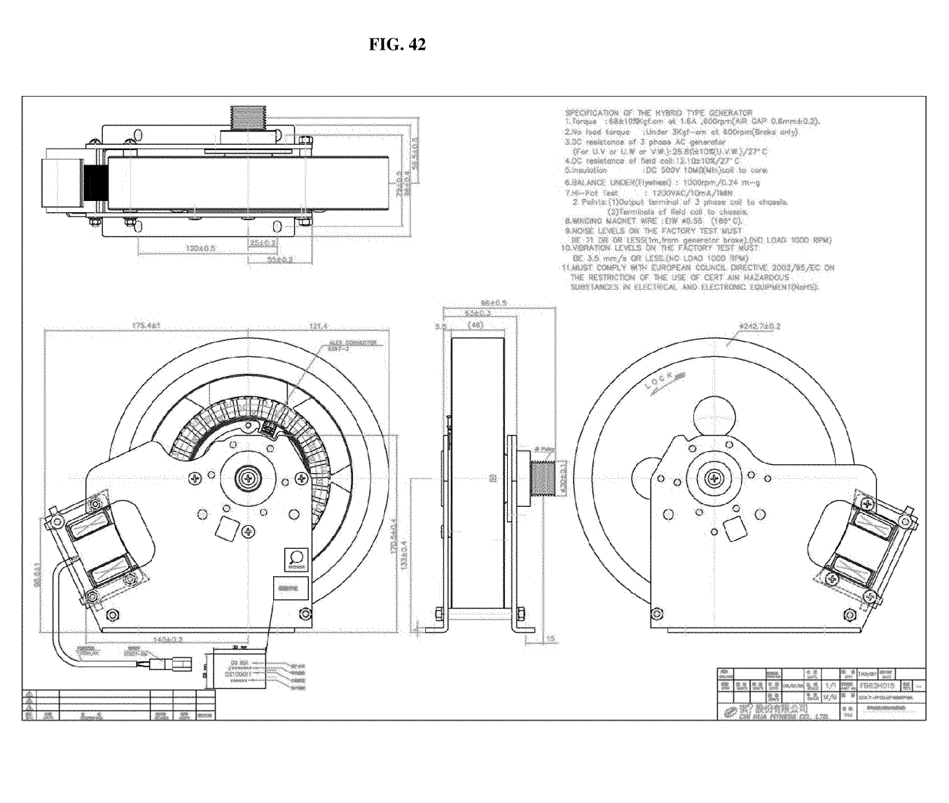

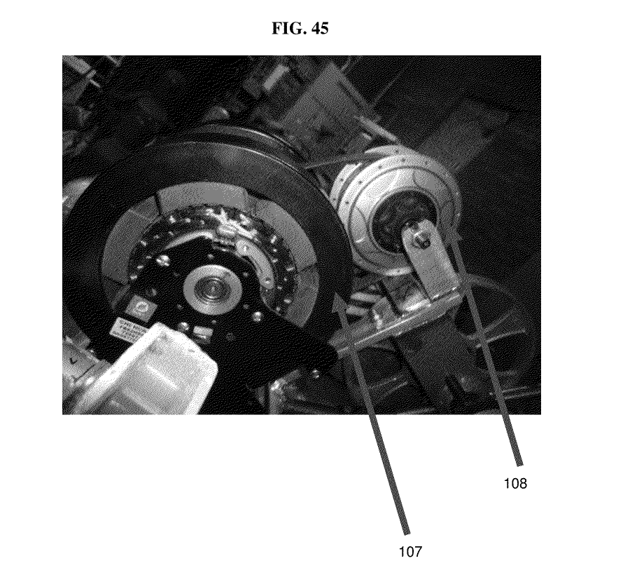

In one embodiment, the vehicle may be programmable like an exercise bicycle and ideally will behave like an exercise bicycle. As a user pedals, the user's work output is fed into two flywheel AC generators 107 (see FIG. 45). FIGS. 41 and 42 illustrate the flywheel generator 107 used. Both generators are identical and connected by belt to an infinitely variable in-hub bicycle transmission 108, such as the NUVINCI technology from Fallbrook Technologies, Inc. of San Diego, Calif., which in turn is connected by belt to a pulley with the pedals & cranks attached. In some embodiments, the flywheel generator 107 may have the following specifications:
1. Torque: 68±10% Kgf-cm at 1.6 A, 600 rpm (Air Gap 0.6 mm±0.2). (1 Kgf=9.8 Newtons)
2. No load torque: Under 3 Kgf-cm at 600 rpm (Brake only)
3. DC resistance of 3 phase AC generator: (for U.V or U.W or V.W.): 26.8Ω±10% (V.V.W.)/27° C.
4. DC Resistance of field coil: 12.1Ω±10%/27° C.
5. Insulation: DC 500V, 10MΩ (Min) coil to core
6. Balance under (Flywheel): 1000 rpm/0.24 m-g
7. Hi-Pot Test: 1200VAC/10 mA/1 min
8. Winding Magnet Wire: EIW φ0.55 (180° C.)

Both generators are connected to the battery and both are controlled by a computing device. The computing device is connected to a microcontroller, such as an Arduino circuit board that can receive input from a computing device and then control a servomotor and gear shifter.

In one embodiment of the vehicle, there are two ways the computer controls pedal resistance. One output from the microcontroller goes to a DC voltage controlled electronic dimmer switch; another output goes to a servomotor connected to the gear shifter.

The microcontroller output going to the dimmer switch is wired in between the flywheel generators and battery. A computer program activates the microcontroller, which then in turn activates the dimmer switch to open and close the dimmer. When open, more current is allowed to flow through; when closed, current flow is prevented. The varying pedal resistance the user feels as he/she pedals the vehicle is a result of varying levels of charge current going to the battery. The more open the dimmer switch is, the harder it is to pedal; the more closed, the easier it is to pedal. The exercise program on the computing device controls the electronic dimmer switch. When the exercise profile calls for steep hills, the electronic dimmer switch opens up all the way, allowing the most current to pass through, thus putting a greater load on the generators and making it harder to pedal. When the program calls for flat stretches, the dimmer switch closes and permits less current to go to the battery.

The microcontroller output going to the servomotor physically moves the controller of a gear adjustment dial of the infinitely variable in-hub bicycle transmission internal hub gear. When the computing device calls for more resistance, the servo shifts the gear-adjusting dial to a higher (more difficult) gear and when the computing device calls for less resistance, the servo shifts the gear dial to a lower (easier) gear.

The electronic dimmer switch system and the servo gear shifting systems work in concert to provide the most efficient and variable pedal resistance charging possible.

The Double Reduction, Dual Generator Pedal System

Conventional bike-powered generators rely on a large bike tire (26″ and bigger) to turn the much smaller crank on the generator. This reduction causes the generator to spin fast—the bigger the bike wheel, the faster the generator and the higher the power output. Ideally, you would have a 35″ or larger wheel spinning the generator, but that is not practical for a small vehicle like that disclosed herein.

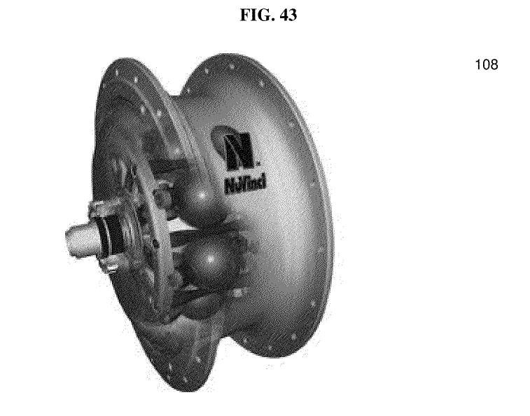

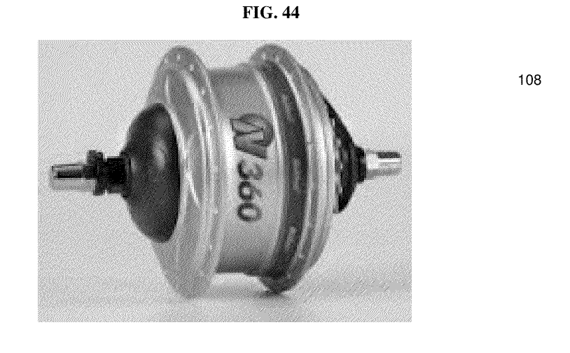

The solution is a double reduction gearing that will spin the generator faster than a 35″ wheel, but in a smaller, more compact space. The use of an infinitely variable in-hub bicycle transmission 108 (see FIGS. 43 and 44) saves more space. Instead of having to have two large pulleys for the double reduction, one smaller pulley and the in-hub gear system will accomplish the same task.

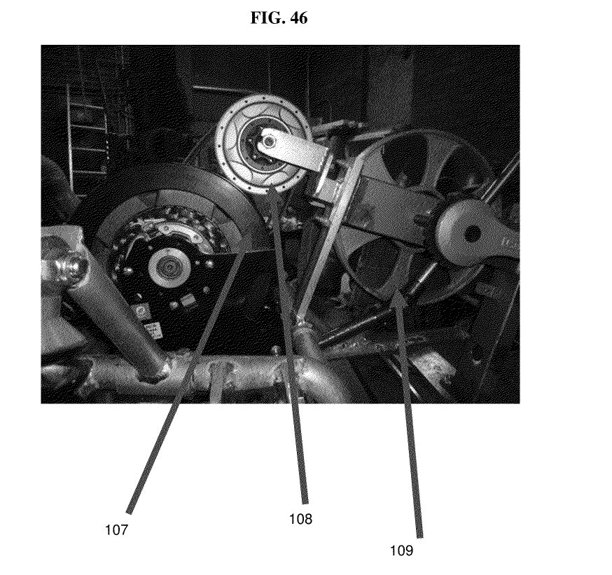

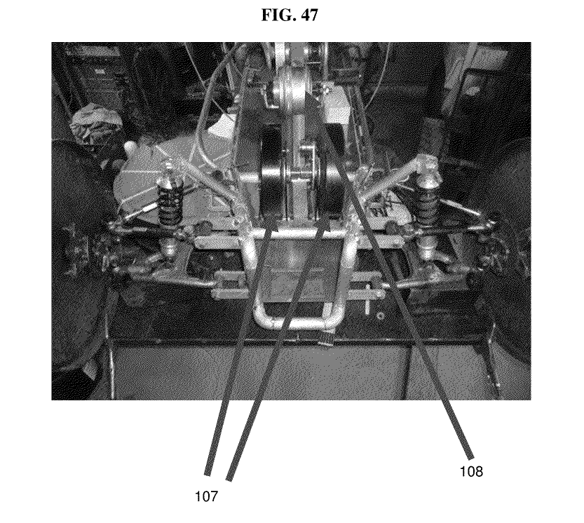

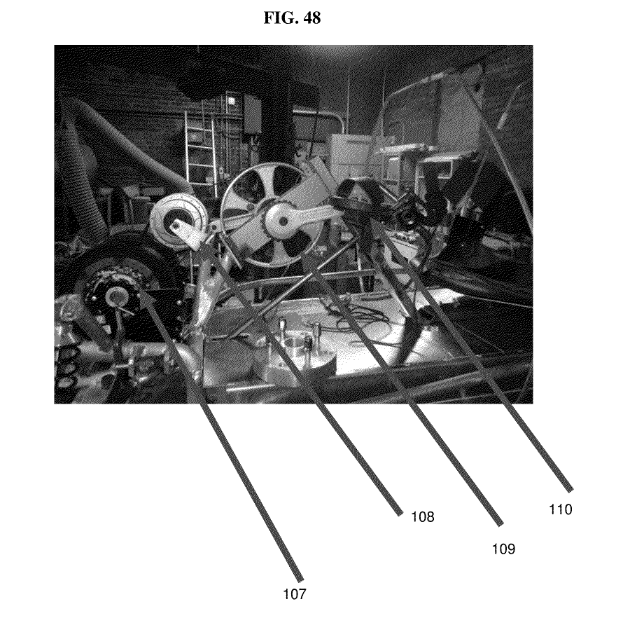

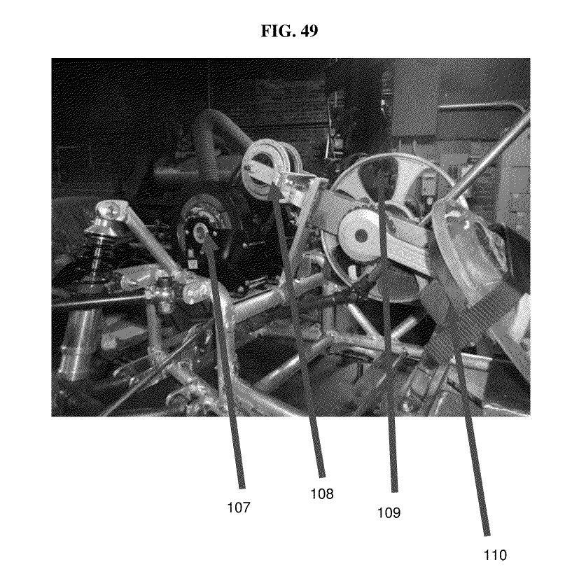

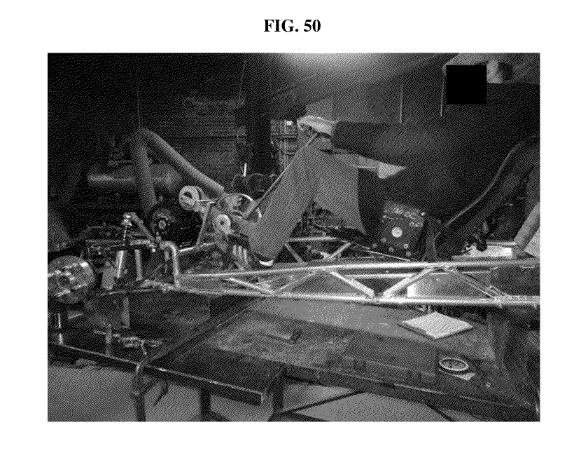

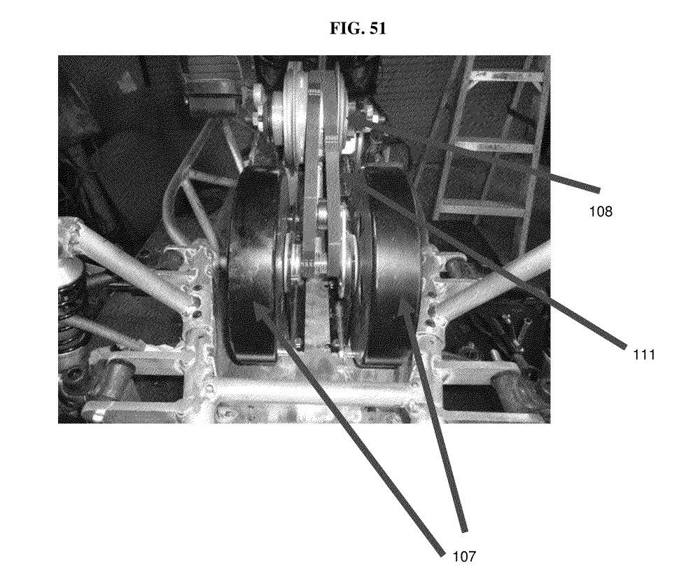

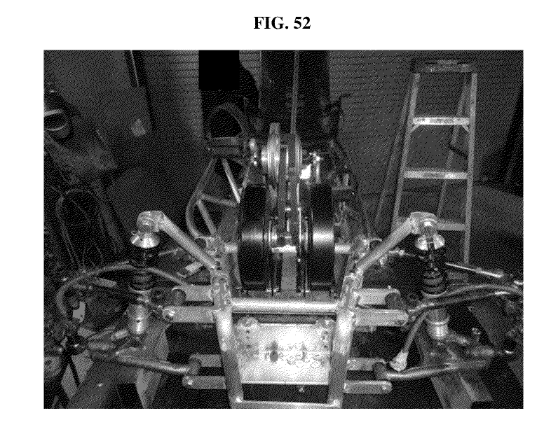

Pedals are directly connected to an 11″ pulley that is connected by a belt to the in-hub gear system. The in-hub gear system is in turn connected directly to the two AC generators with clutches. The in-hub gear system is an infinitely variable, totally enclosed rear wheel bicycle hub gear. It is intended for use with bicycles, but works in the disclosed vehicle because even though it is a high-speed electric vehicle, the pedal cadences are still those of a typical bicycle. FIGS. 45 through 52 illustrate the double reduction, dual generator pedal system.

As illustrated in FIGS. 45 through 52, the infinitely variable in-hub bicycle transmission 108 is attached to the flywheel generators 107 by belts 111. A pulley 109 is attached to the pedal cranks 110.

The generators are wired in parallel. Two generators won't necessarily make twice as much power, but two generators in parallel will provide the amps the disclosed vehicle needs at lower generator RPM's.

### Outboard Mode

The human power energy generation system can be switched to outboard mode. In this mode, appliances, batteries, or other items requiring a power source can be plugged into the vehicle. In this mode, the vehicle becomes a portable human generator. This feature makes the vehicle a form of transportation and a transportable source of electric power. The vehicle could, for instance, be used for emergencies or in locations without access to a conventional electrical grid.

The ECVRR system and the double reduction, dual generator systems enable the vehicle and rider to vary the resistance, send all the power that the person generates to the batteries without throwing any of it away and generate enough power so that the rider contributes to the battery as much as physically possible. The disclosed vehicle is designed to achieve highly efficient electrical power production.

### I) User Interface

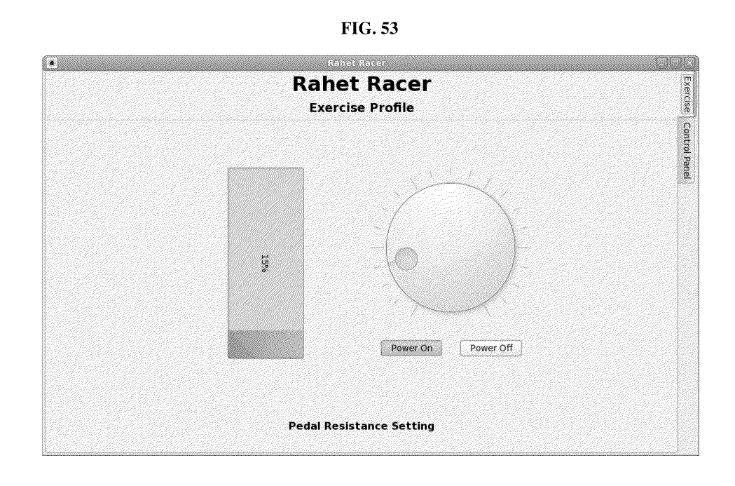

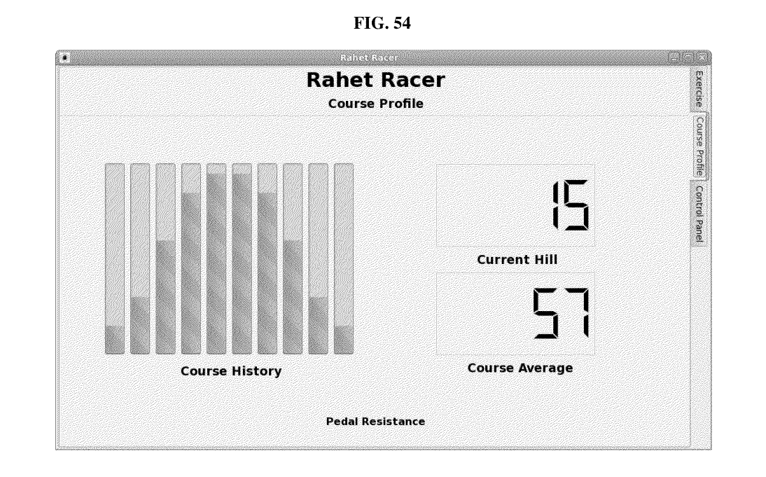

In some embodiments, the vehicle includes a computing device, for example, a touchpad or tablet computer. The vehicle may use a simple touchpad screen situated in front of the driver to control vehicle functions. Typical electric vehicle information such as speed, odometer, percentage of charge remaining, battery drain rate, amps, charging stations, lighting controls, ventilation controls and alarm could be displayed on one screen of the tablet. The driver can switch screens to access the exercise program functions. FIGS. 53 and 54 show examples of screen graphics that might be displayed on the vehicle's touchpad screen.

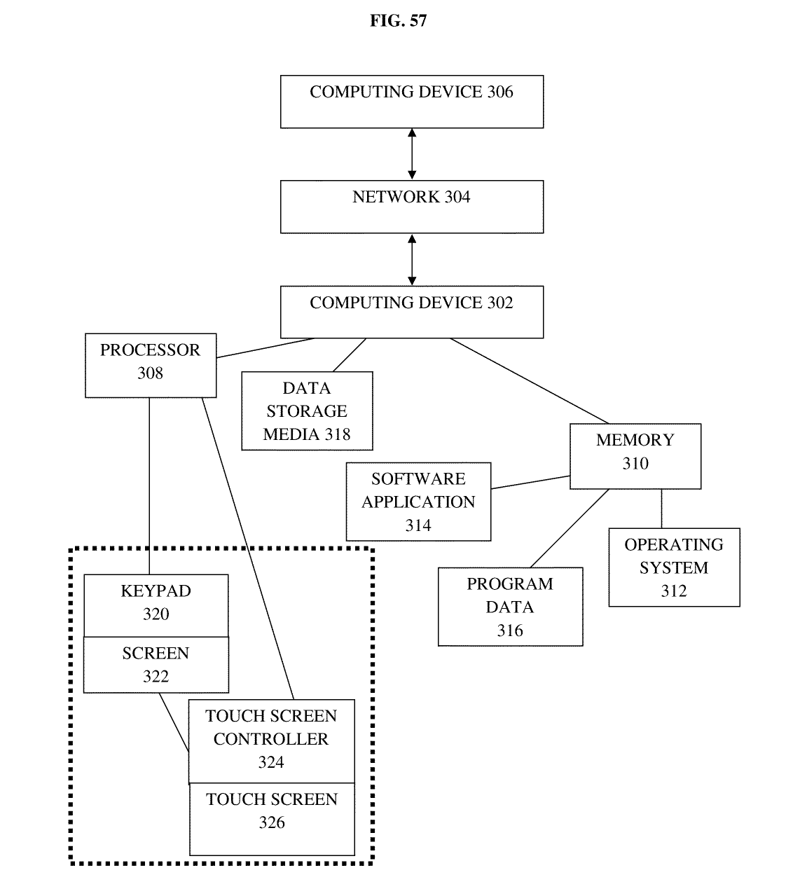

FIG. 57 is a schematic block diagram of an example computing device 302 that may be used in some embodiments of the vehicle. Computing device 302 can be, for example, a smart phone or other mobile device, a tablet computing device, a netbook, a computing device built in to the vehicle or any other portable or mobile computing device. Computing device 302 can be a stand-alone computing device 302 or a networked computing device that communicates with one or more other computing devices 306 across network 304. Computing device 306 can be, for example, located remote from computing device 302, but configured for data communication with computing device 302 across network 304. Computing device 306 can be, for example, a server.

In some examples, the computing device 302 includes at least one processor or processing unit 308 and system memory 310. Depending on the exact configuration and type of computing device, the system memory 310 may be volatile (such as RAM), non-volatile (such as ROM, flash memory, etc.) or some combination of the two. System memory 310 typically includes an operating system 312 suitable for controlling the operation of the computing device, such as the WINDOWS® operating systems from Microsoft Corporation of Redmond, Wash. or a server, such as Windows SharePoint Server, also from Microsoft Corporation. To provide further example, if the computing device 302 is a smart phone, tablet or other mobile device, the operating system 312 may be Android, iOS, or any other available mobile operating system. The system memory 310 may also include one or more software application(s) 314 and may include program data 316. The one or more software applications 314 may be in the form of mobile applications in examples wherein the computing device is a mobile device.

The computing device may have additional features or functionality. For example, the device may also include additional data storage devices 318 (removable and/or non-removable) such as, for example, magnetic disks, optical disks, or tape. Computer storage media 318 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, the computing device 302 can be a tablet computer or other mobile device positioned in front of the driver in the vehicle described herein. The computing device 302 may have input device options including, but not limited to, a keypad 320, a screen 322, a touch screen controller 324, and/or a touch screen 326. In some embodiments, electric vehicle information and exercise program functions are stored as data instructions for a software application 314 on the computing device 302. A network 304 may facilitate communication between the computing device 302 and one or more servers, such as computing device 306, to facilitate the electric vehicle operations, displays and functions associated with the computing device 302, as described herein. The network 304 may be a wide variety of different types of electronic communication networks. For example, the network may be a wide-area network, such as the Internet, a local-area network, a metropolitan-area network, a cellular network or another type of electronic communication network. The network may include wired and/or wireless data links. A variety of communications protocols may be used in the network 304 including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, computing device 306 is a Web server. In this example, computing device 302 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of computing devices 302 and 306, the instructions cause the processor to perform one or more of the operations or methods disclosed herein. Examples of operations include displaying vehicle information, exercise program functions, and providing location information/directions using GPS-enabled software applications.

The computing device 302 may include image capture devices, whether a dedicated video or image capture device, smart phone or other device that is capable of capturing images and video. Further, the computing device 302 may be a tablet computer or smart phone with native or web-based applications that can capture, store and transmit time-stamped video and images to a central server. The computing device 302 can also include location data captured by a GPS-enabled application or device. The computing device 302 may also have WiFi or 3G capabilities.

### J) Other User Controls

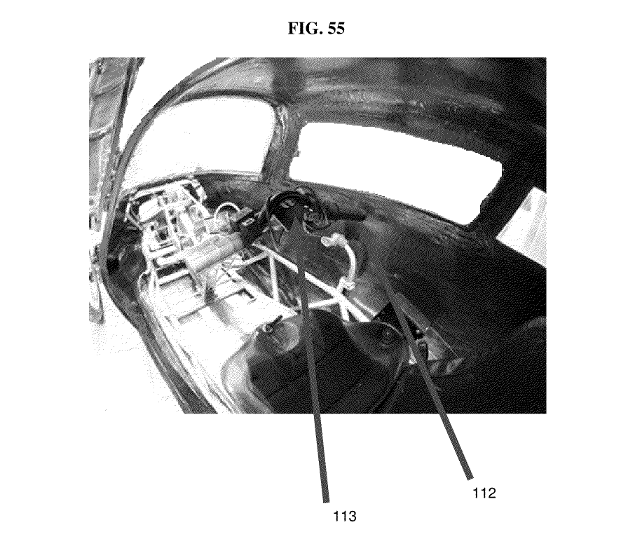

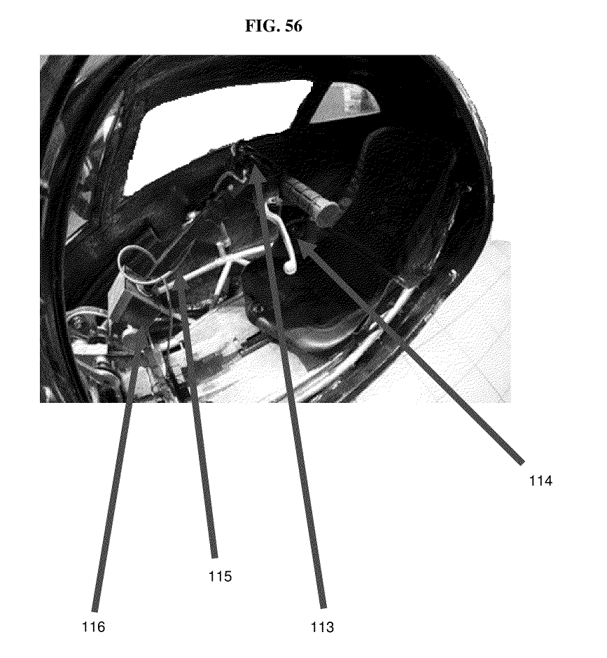

In one embodiment, steering can be accomplished by a number of different means, including a standard steering wheel sized to fit the internal dimensions of the vehicle, handlebars, plane-style yolk, or other means. In addition, the vehicle can be outfitted with brake and accelerator pedals in a floor mount position or by the steering control (as on a motorcycle). FIGS. 55 and 56 illustrate the steering wheel controls, including a throttle 112, steering wheel 113, front brakes lever 114, steering column 115, and steering column pivot adjust 116. Turn signals and lights may also be utilized. Such lights could be mounted to the body or made integral to the body (built in) to reduce aerodynamic drag.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. An electrically propelled vehicle comprising:
a body configured to hold at least one human,
a drive train,
a power source,
a steering system,
a braking system,
pedals allowing for power input by a human, and
a computing system including a graphical interface.

2. The electrically propelled vehicle of claim 1, wherein the power supply is at least one battery.

3. The electrically propelled vehicle of claim 2, wherein the braking system is a regenerative braking system.

4. The electrically propelled vehicle of claim 2, wherein the power supply is configured to be recharged by alternating current.

5. The electrically propelled vehicle of claim 2, wherein the computing system is configured to increase and decrease an amount of resistance provided by the pedals.

6. The electrically propelled vehicle of claim 2, further comprising a solar panel configured to intake solar energy and provide electricity to the power supply.

7. The electrically propelled vehicle of claim 5, wherein the computing system is configured to provide pedal resistance according to at least one pre-programmed exercise program.

8. The electrically propelled vehicle of claim 5, wherein the computing system is configured to provide pedal resistance according to a custom exercise program.
